(19) United States
(12) Patent Application Publication
(10) Pub. No.: US 2022/0298823 A1
(43) Pub. Date: Sep. 22, 2022

(54) MODULAR POLE, JOINT FOR MODULAR POLE, AND FASTENER FOR CONNECTING MODULAR POLE MODULES

(71) Applicant: Allpole, LLC, Hinckley, OH (US)

(72) Inventor: Harri T. RAUMA, Langley (CA)

(73) Assignee: Allpole, LLC, Hinckley, OH (US)

(21) Appl. No.: 17/655,277

(22) Filed: Mar. 17, 2022

Related U.S. Application Data
(60) Provisional application No. 63/162,154, filed on Mar. 17, 2021.

(51) Int. Cl. E04H 12/34; F16B 7/18

(52) U.S. Cl. CPC E04H 12/34; F16B 7/18

(57) ABSTRACT

A joint for a modular pole comprises a lower flange, an upper flange, and a transition section. The lower flange may have a lower flange external dimension which is greater than an upper flange external dimension. A fastener which may be useful in connecting the joint to a pipe or a stud comprises a through hole having an inner thread which does not span the entire distance of the through hole, and an outer thread on an exterior surface of the fastener with the inner thread and the outer thread having opposing thread directions. A modular pole comprises Pₙ₊₁ pipes, Tₙ joints, and a plurality of fasteners where n is an integer greater than or equal to 1.

### CROSS REFERENCES AND PRIORITIES

This application claims priority from U.S. Provisional Application No. 63/162,154 filed on 17 Mar. 2021 the teachings of which are incorporated by reference herein in their entirety.

### BACKGROUND

Poles are used throughout society for a variety of purposes including utility poles, light poles, architectural poles, and load bearing poles for displaying signage. In general, poles come in three main varieties. First are straight poles having a substantially similar external dimension from the lower end of the pole to the upper end of the pole. Second are tapered poles having a dimension at the lower end of the pole which is greater than the dimension at the upper end of the pole and a progressively decreasing dimension along the length of the pole. Finally, step poles have a plurality of sections with each section having a substantially similar external dimension from its lower end to its upper end, and a step down between each section which decreases the external dimension of the sections as the pole extends upwards.

In practice, the process of manufacturing and installing a pole is rife with inefficiency and waste. For example, poles are often manufactured and shipped as a single piece of material. The poles may be manufactured as a single continuous piece of material, or as multiple pieces of material which are permanently joined to one another, such as by welding. The manufacturing process therefore often requires an exceptionally large factory footprint to allow for transport through the factory for various stages of manufacturing. The manufacturing process is also energy inefficient owing to the amount of cutting, grinding, and welding which must take place to assemble a single pole.

Additionally, poles often require post-manufacturing surface treatments such as galvanizing, painting or powder coating. As the pole generally has a long hollow interior, drain holes must be placed along the length of the pole to allow excess coating materials to be removed from the pole interior during the surface treatment process. After surface treatment, these drain holes must then be plugged—such as by welding—leading to additional manufacturing time and energy waste.

Shipping poles to a site for installation suffers from additional inefficiency. As the poles are manufactured of a single long piece of material, they require lengthy rail cars, trailers, or flatbed trucks to transport to the job site for installation. As the poles often have a significant length, the number of poles which may be shipped on any one truck or rail car is relatively small. This requires more vehicles—and therefore more energy waste—to ship a relatively small number of poles.

Installation of the pole can also incur additional waste. As the pole is installed as a single continuous unit, a large amount of space is needed to remove the pole from its shipping vehicle, tilt the pole to a vertical orientation, and securely attach the pole to the ground surface.

The need exists, therefore, for a pole which is more efficient to manufacture, ship, and install.

### SUMMARY

It is disclosed herein a joint for a modular pole. The joint comprises a lower flange, an upper flange and a transition section. The lower flange comprises at least one lower flange hole passing through a lower flange first sidewall perpendicular to a joint central axis. The upper flange comprises at least one upper flange hole passing through an upper flange first sidewall perpendicular to the joint central axis. The transition section connects the lower flange to the upper flange. The lower flange has a lower flange external dimension perpendicular to and encompassing the joint central axis which is greater than an upper flange external dimension perpendicular to and encompassing the joint central axis.

In some embodiments, at least one of the lower flange holes may be threaded. For example, each of the lower flange holes may be threaded.

In certain embodiments, at least one of the upper flange holes may be threaded. For example, each of the upper flange holes may be threaded.

In some embodiments, each of the upper flange and the lower flange may have a circular radial cross-sectional profile. In some such embodiments, the upper flange may have an upper flange outer diameter of approximately 10 in. and the lower flange may have a lower flange outer diameter of approximately 12 in. In other such embodiments, the upper flange may have an upper flange outer diameter of approximately 8 in. and the lower flange may have a lower flange outer diameter of approximately 10 in. In still other such embodiments, the upper flange may have an upper flange outer diameter of approximately 6 in. and the lower flange may have a lower flange outer diameter of approximately 8 in. In yet other such embodiments, the upper flange may have an upper flange outer diameter of approximately 5 in. and the lower flange may have a lower flange outer diameter of approximately 6 in. In still other such embodiments, the upper flange may have an upper flange outer diameter of approximately 4 in. and the lower flange may have a lower flange outer diameter of approximately 6 in. In yet other such embodiments, the upper flange may have an upper flange outer diameter of approximately 4 in. and the lower flange may have a lower flange outer diameter of approximately 5 in.

In certain embodiments, each of the upper flange and the lower flange may have a circular polygonal cross-sectional profile. In some such embodiments, the upper flange may have an upper flange outer dimension of approximately 10 in. and the lower flange may have a lower flange outer dimension of approximately 12 in. In other such embodiments, the upper flange may have an upper flange outer dimension of approximately 8 in. and the lower flange may have a lower flange outer dimension of approximately 10 in. In still other such embodiments, the upper flange may have an upper flange outer dimension of approximately 6 in. and the lower flange may have a lower flange outer dimension of approximately 8 in. In yet other such embodiments, the upper flange may have an upper flange outer dimension of approximately 5 in. and the lower flange may have a lower flange outer dimension of approximately 6 in. In still other such embodiments, the upper flange may have an upper flange outer dimension of approximately 4 in. and the lower flange may have a lower flange outer dimension of approximately 6 in. In yet other such embodiments, the upper flange may have an upper flange outer dimension of approximately 4 in. and the lower flange may have a lower flange outer dimension of approximately 5 in.

In some embodiments, the at least one upper flange hole may comprise a number of upper flange holes selected from the group consisting of at least two, at least four, at least six, and at least eight. In certain embodiments, the at least one lower flange hole may comprise a number of upper flange holes selected from the group consisting of at least two, at least four, at least six, and at least eight.

It is also disclosed herein a fastener. The fastener comprises a through hole, an inner thread, and an outer thread. The through hole passes from a fastener first end to a fastener second end which is opposite the fastener first end. The inner thread is inside the through hole and spans along a first distance originating from the fastener first end and terminating before the fastener second end. The outer thread is on an exterior surface of the fastener spanning along a second distance originating from the fastener second end and terminating before the fastener first end. The inner thread has an inner thread direction while the outer thread has an outer thread direction with the inner thread direction being opposite the outer thread direction.

In some embodiments of the fastener, the first distance does not overlap with the second distance. In certain embodiments, a third distance of the exterior surface originating from the fastener first end and terminating before the fastener second end may have an axial cross-sectional profile which is hexagonal. Some embodiments of the fastener may further comprise a bolt comprising external threads which are mated to the inner thread.

In certain embodiments of the fastener, the inner thread direction may be a left-hand thread direction and the outer thread direction may be a right-hand thread direction. In other embodiments of the fastener, the inner thread direction may be a right-hand thread direction and the outer thread direction may be a left-hand thread direction.

Further disclosed herein is a modular pole. The modular pole comprises Pₙ₊₁ pipes, Tₙ joints, and a plurality of fasteners where n is an integer greater than or equal to 1. Each joint may has a lower flange, an upper flange, a transition section connecting the lower flange to the upper flange, at least one lower flange hole passing through a lower flange first sidewall perpendicular to a joint central axis, and at least one upper flange hole passing through an upper flange first sidewall perpendicular to the joint central axis. Each pipe has a pipe first end, a pipe second end, at least one first pipe hole passing through a sidewall of the pipe first end, and at least one second pipe hole passing through the sidewall of the pipe at the pipe second end. The lower flange of each joint has a first external dimension perpendicular to and encompassing the joint central axis which is greater than a second external dimension of the upper flange of said joint perpendicular to and encompassing the joint central axis. A first subset of the plurality of fasteners is configured to fixedly connect a first pipe of the Pₙ₊₁ pipes to a first joint of the Tₙ joints by passing each fastener of the first subset through one of the lower flange holes of the first joint and one of the second pipe holes of the first pipe. A second subset of the plurality of fasteners is configured to fixedly connect the first joint to a second pipe of the Pₙ₊₁ pipes by passing each fastener of the second subset through one of the upper flange holes of the first joint and one of the first pipe holes of the second pipe.

Some embodiments of the modular pole may further comprise a base plate comprising a stud extending substantially vertically therefrom. In some such embodiments, one pipe of the Pₙ₊₁ pipes may have an internal dimension perpendicular to a pipe central axis which is greater than a third external dimension of the stud perpendicular to the pipe central axis.

In some embodiments, the stud may comprise at least one stud hole passing through a sidewall of the stud. In certain such embodiments, a third subset of the plurality of fasteners may be configured to fixedly connect the one pipe to the stud by passing each fastener of the first subset through one of the first pipe holes of the one pipe and one of the stud holes. In some such embodiments, at least one of the stud holes may be threaded. For example, each of the stud holes may be threaded.

In certain embodiments of the modular pole, each upper flange, each lower flange, and each pipe may have a circular radial cross-sectional profile. In other embodiments of the modular pole, each upper flange, each lower flange, and each pipe may have a polygonal radial cross-sectional profile.

In some embodiments of the modular pole, at least one of the lower flange holes of each joint may be threaded. For example, each of the lower flange holes of each joint may be threaded.

In certain embodiments of the modular pole, each of the lower flange holes of each joint may be threaded. For example, each of the upper flange holes of each joint may be threaded.

In some embodiments of the modular pole, the plurality of fasteners may comprise at least one fastener comprising a through hole, an inner thread, and an outer thread. The through hole may pass from a fastener first end to a fastener second end which is opposite the fastener first end. The inner thread may be inside the through hole and spans along a first distance originating from the fastener first end and terminating before the fastener second end. The outer thread may be on an exterior surface of the fastener spanning along a second distance originating from the fastener second end and terminating before the fastener first end. The inner thread may have an inner thread direction while the outer thread has an outer thread direction with the inner thread direction being opposite the outer thread direction.

In some such embodiments of the modular pole, the first distance does not overlap with the second distance. In certain embodiments, a third distance of the exterior surface originating from the fastener first end and terminating before the fastener second end may have an axial cross-sectional profile which is hexagonal. Some embodiments may further comprise a bolt comprising external threads which are mated to the inner thread.

In certain embodiments of the modular pole, the inner thread direction may be a left-hand thread direction and the outer thread direction may be a right-hand thread direction. In other embodiments, the inner thread direction may be a right-hand thread direction and the outer thread direction may be a left-hand thread direction.

In some embodiments, the modular pole may further comprise a ladder. The ladder may have at least one ladder collar. Each ladder collar may be configured to connect to at least one of the pipes.

### BRIEF DESCRIPTION OF FIGURES

FIG. 1 is an exploded perspective view of one embodiment of a modular pole as disclosed herein.

FIG. 2 is an assembled perspective view of the embodiment of a modular pole shown in FIG. 1.

FIG. 3 is an axial cross section view of one embodiment of a joint as disclosed herein.

FIG. 4A is a top view of the embodiment of a joint shown in FIG. 3.

FIG. 4B is a bottom view of the embodiment of a joint shown in FIG. 3.

FIG. 5 is an axial cross section view of another embodiment of a joint as disclosed herein.

FIG. 6A is a top view of the embodiment of a joint shown in FIG. 5.

FIG. 6B is a bottom view of the embodiment of a joint shown in FIG. 5.

FIG. 7 is an exploded axial cross section view of an embodiment of a joint connecting two pipes.

FIG. 8 is an assembled axial cross section view of the embodiment of a joint connecting two pipes of FIG. 7.

FIG. 9 is a side view of an embodiment of a fastener as disclosed herein.

FIG. 10 is an axial cross section view of the fastener of FIG. 9.

FIG. 11 is an assembled side view of an embodiment of a joint connecting two pipes.

FIG. 12 is an assembled perspective view of the embodiment of a joint connecting two pipes of FIG. 11.

FIG. 13 is an assembled top view of the embodiment of a joint connecting two pipes of FIG. 11.

FIG. 14 is an assembled bottom view of the embodiment of a joint connecting two pipes of FIG. 11.

FIG. 15 is an assembled perspective view of an embodiment of a modular pole with a ladder attached.

FIG. 16 is a cross section view of the embodiment of a modular pole with a ladder attached of FIG. 15.

### DETAILED DESCRIPTION

Disclosed herein is a joint for a modular pole. Also disclosed herein is a fastener useful for assembling a modular pole. Further disclosed herein is a modular pole. As described herein and in the claims, the following numbers refer to the following structures as noted in the Figures.
10 refers to a modular pole.
100 refers to a joint.
110 refers to a lower flange.
112 refers to a lower flange hole.
114 refers to a lower flange outer diameter.
116 refers to a lower flange outer dimension.
118 refers to a lower flange lip.
120 refers to an upper flange.
122 refers to an upper flange hole.
124 refers to an upper flange outer diameter.
126 refers to an upper flange outer dimension.
128 refers to an upper flange lip.
130 refers to a transition section.
140 refers to a joint central axis.
150 refers to a ladder connection mechanism.
200 refers to a pipe.
210 refers to a pipe first end.
220 refers to a pipe second end.
230 refers to a first pipe hole.
240 refers to a second pipe hole.
250 refers to a pipe central axis
300 refers to a fastener.
310 refers to a fastener first end.
320 refers to a fastener second end.
330 refers to a through hole.
340 refers to an inner thread.
342 refers to a first distance.
350 refers to an exterior surface.
352 refers to a third distance.
360 refers to an outer thread.
362 refers to a second distance.
370 refers to a bolt.
372 refers to external threads.
374 refers to a bolt first end.
376 refers to a bolt second end.
400 refers to a base plate.
410 refers to a stud.
412 refers to a stud hole.
500 refers to a ladder.
510 refers to a ladder brace.
520 refers to a ladder collar.

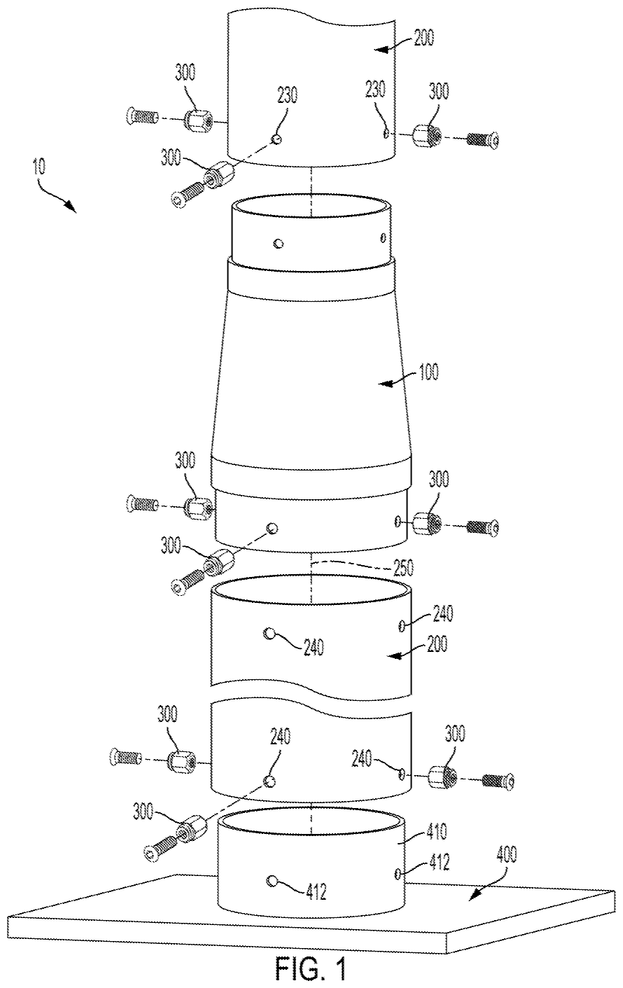

FIG. 1 depicts an exploded perspective view of one embodiment of a modular pole (10) as described herein. As shown in FIG. 1, the modular pole may comprise at least Tₙ joints (100) and at least Pₙ₊₁ pipes (200) where n is an integer greater than or equal to 1. That is to say that each modular pole will comprise one more pipe than the number of joints of the modular pole. For example, when the modular pole comprises a single joint, the modular pole will comprise two pipes. As another example, when the modular pole comprises two joints, the modular pole will comprise three pipes. The number of pipes and number of joints in any one individual modular pole is not considered important for purposes of the invention, and will depend upon a number of factors including the intended use for the pole and the desired height and width of the pole.

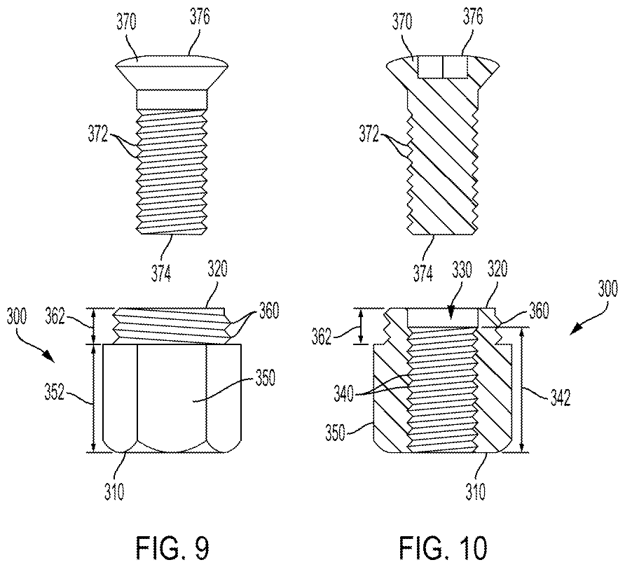

The modular pole (10) may also comprise a plurality of fasteners (300). While the preferred fasteners are described herein and shown in FIGS. 9 and 10, other types of fasteners may be utilized. Non-limiting examples of such fasteners include a bolt, a bolt and nut, a screw, and a rivet.

In some embodiments, the modular pole (10) may also comprise a base plate (400) as shown in FIG. 1. The preferred base plate is a flat sheet of material—preferably having a polygonal shape such as square or a rectangle. The type of material used to construct the base plate is not considered important, but in general the base plate will be constructed of a rigid material with steel, stainless steel, and cast iron being non-limiting examples of such materials.

In certain embodiments, the base plate (400) may comprise a stud (410) extending from a top surface thereof substantially perpendicular to or perpendicular to the base plate plane. The stud may be attached to the top surface of the base plate by an number of mechanisms, including by welding the stud to the top surface of the base plate, or manufacturing the stud and the base plate of a single piece of material such as by casting.

When present, the stud (400) may be sized and shaped to allow one pipe of the Pₙ₊₁ pipes (200) to fit over at least a portion of the stud. That is to say that the stud preferably has a radial cross-sectional profile which is substantially similar in shape as that of the one pipe, and the one pipe has internal dimensions perpendicular to a pipe central axis (250) which are greater than the external dimensions of the stud perpendicular to the pipe central axis. As used herein and in the claims, the term “external dimensions” refers to the perimeter of the stud when viewed in an axial cross section.

In some embodiments, the stud (400) may comprise at least one stud hole (412). When present, the stud hole(s) will pass through a stud sidewall. The location of the stud hole(s) will preferably be adapted to the location of a subset of corresponding pipe hole(s) (240) in the one pipe. Doing so allows for a subset of the plurality of fasteners (300) to fixedly connect the one pipe to the stud by passing each fastener of the subset through one of the pipe holes of the one pipe and one of the stud holes. As used herein and in the claims, the term “fixedly connect” indicates that the connection limits or eliminates the ability of a component—such as a pipe or a joint—to be moved about its central axis and/or parallel to its central axis.

In some embodiments, the modular pole (10) may be in the form of a modular pole kit. The modular pole kit may comprise Pₙ₊₁ pipes of the type disclosed herein, Tₙ joints of the type disclosed herein, and a plurality of fasteners of the type disclosed herein. In some embodiments, the modular pole kit may further comprise a base plate of the type disclosed herein.

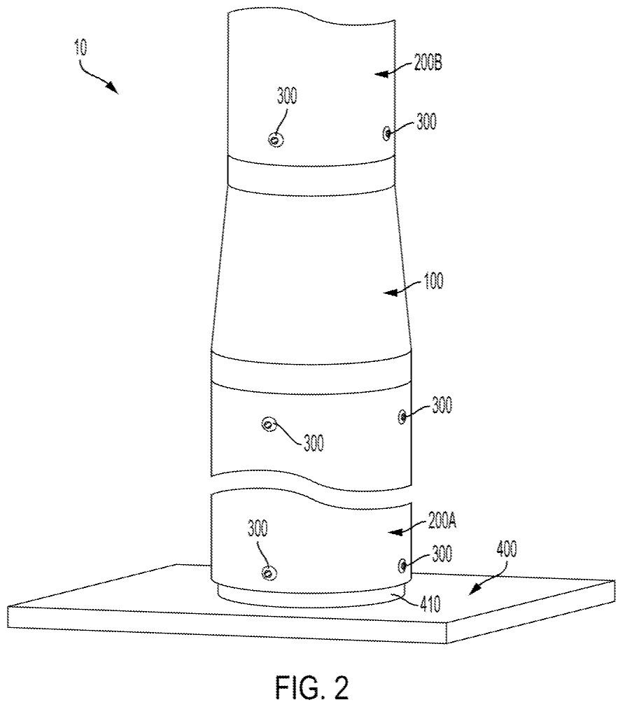

FIG. 2 depicts an assembled perspective view of the modular pole (10) of FIG. 1. As shown in FIG. 2, the modular pole has been assembled by passing one pipe (200A) at least partially over the stud (410) which is attached to a top surface of the base plate (400), depositing the joint (100) partially into the one pipe, and passing a second pipe (200B) partially over the joint. The fasteners (300) are then used to fixedly connect the one pipe to the stud, the one pipe to the joint, and the second pipe to the joint. Once assembled, the stud may be referred to as nested—at least partially—within the one pipe, while the joint may be referred to as partially nested within the one pipe and the second pipe.

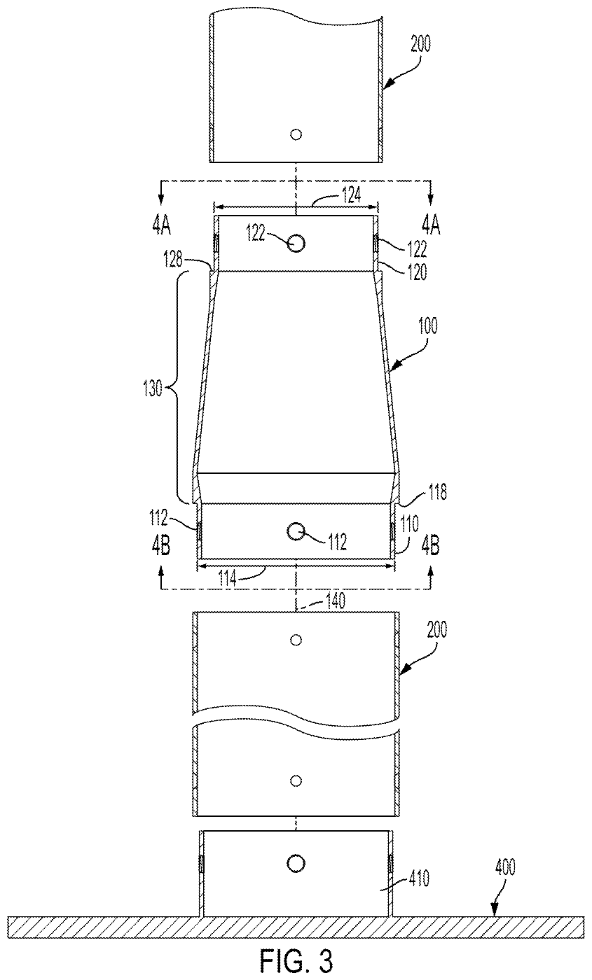

FIG. 3 depicts an axial cross section view of one embodiment of a joint (100). As shown in FIG. 3, the joint may comprise a lower flange (110), an upper flange (120), and a transition section (130) which connects the lower flange to the upper flange. The lower flange will have a lower flange external dimension perpendicular to and encompassing a joint central axis (140). This lower flange external dimension is preferably greater than an upper flange external dimension with the upper flange external dimension being perpendicular to and encompassing the joint central axis. However, in certain embodiments, the lower flange external dimension may be equal to or substantially equal to the upper flange external dimension. As used herein and in the claims, the term “external dimension” refers to the perimeter of the lower flange or the upper flange when viewed in an axial cross section.

In preferred embodiments, there will be a lower flange lip (118) between the lower flange and the transition section, and an upper flange lip (128) between the upper flange and the transition section. The lower flange lip and the upper flange lip provide a surface against which an end of pipe may be disposed when the modular pole is assembled.

The lower flange (110) will comprise at least a lower flange first sidewall. As shown in FIG. 3, there may be at least one lower flange hole (112) passing through the lower flange sidewall in a direction perpendicular to a joint central axis (140). The number of lower flange hole(s) is not considered important and will depend upon a number of factors. That is to say that the at least one lower flange hole may comprise a number of lower flange holes selected from the group consisting of at least two, at least four, at least six, and at least eight. In some embodiments, at least one of the lower flange holes may be threaded to allow for said lower flange hole to receive threads of a fastener—such as a bolt, or a fastener of the type described herein and shown in FIG. 9 and FIG. 10. Preferably, each of the lower flange holes will be threaded to allow for said lower flange holes to receive threads of such a fastener.

The upper flange (120) will comprise at least an upper flange first sidewall. As shown in FIG. 3, there may be at least one upper flange hole (122) passing through the upper flange sidewall in a direction perpendicular to the joint central axis (140). The number of upper flange hole(s) is not considered important and will depend upon a number of factors. That is to say that the at least one upper flange hole may comprise a number of upper flange holes selected from the group consisting of at least two, at least four, at least six, and at least eight. In some embodiments, at least one of the upper flange holes may be threaded to allow for said upper flange hole to receive threads of a fastener—such as a bolt, or a fastener of the type described herein and shown in FIGS. 9 and 10. Preferably, each of the upper flange holes will be threaded to allow for said upper flange holes to receive threads of such a fastener.

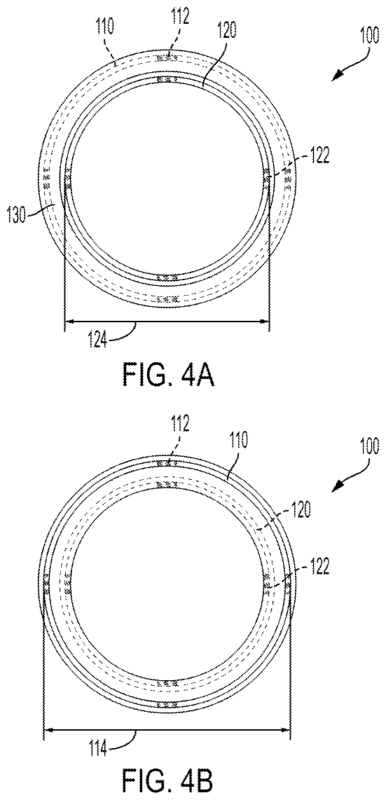

The lower flange (110) and the upper flange (120) may have a variety of different radial cross-sectional profiles. One such radial cross-sectional profile is a circular radial cross-sectional profile as shown in FIG. 4A and FIG. 4B. FIG. 4A shows the joint (100) from a top view showing the upper flange and the transition section (130). FIG. 4B shows the joint from a bottom view showing the lower flange.

When the lower flange (110) and the upper flange (120) have a circular radial cross-sectional profile, each flange will have an outer diameter. That is to say that the lower flange will have a lower flange outer diameter (114 as shown in FIG. 4B) and the upper flange will have an upper flange outer diameter (124 as shown in FIG. 4A).

In embodiments where the lower flange external dimension is greater than the upper flange external dimension, the lower flange outer diameter (114 as shown in FIG. 4B) should be greater than the upper flange outer diameter (124 as shown in FIG. 4A). For example, one embodiment of a joint (100) will have an upper flange having an upper flange outer diameter of approximately 10 in. and a lower flange having a lower flange outer diameter of approximately 12 in. Another example may have an upper flange having an upper flange outer diameter of approximately 8 in. and a lower flange having a lower flange outer diameter of approximately 10 in. Yet another example may have an upper flange having an upper flange outer diameter of approximately 6 in. and a lower flange having a lower flange outer diameter of approximately 8 in. Still another example may have an upper flange having an upper flange outer diameter of approximately 5 in. and a lower flange having a lower flange outer diameter of approximately 6 in. Another example still may have an upper flange having an upper flange outer diameter of approximately 4 in. and a lower flange having a lower flange outer diameter of approximately 6 in. Yet another example may have an upper flange having an upper flange outer diameter of approximately 4 in. and a lower flange having a lower flange outer diameter of approximately 5 in.

In embodiments where the lower flange external dimension is equal to or substantially equal to the upper flange external dimension, the lower flange outer diameter will be equal to or substantially equal to the upper flange outer diameter. For example, one embodiment of a joint (100) will have an upper flange having an upper flange outer diameter of approximately 12 in. and a lower flange having a lower flange outer diameter of approximately 12 in. Another embodiment of a joint will have an upper flange having an upper flange outer diameter of approximately 10 in. and a lower flange having a lower flange outer diameter of approximately 10 in. Still another embodiment of a joint will have an upper flange having an upper flange outer diameter of approximately 8 in. and a lower flange having a lower flange outer diameter of approximately 8 in. Yet another embodiment of a joint will have an upper flange having an upper flange outer diameter of approximately 6 in. and a lower flange having a lower flange outer diameter of approximately 6 in.

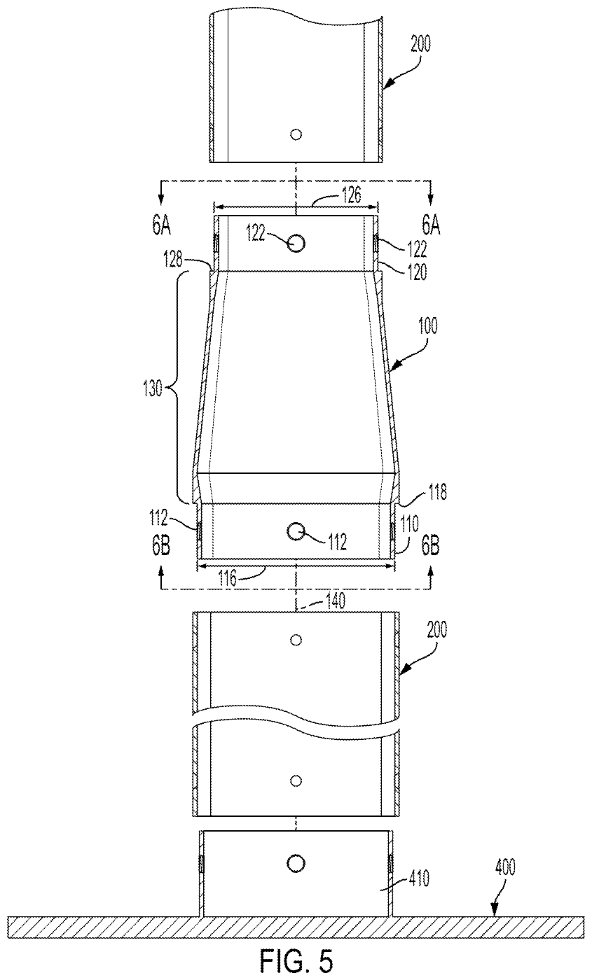

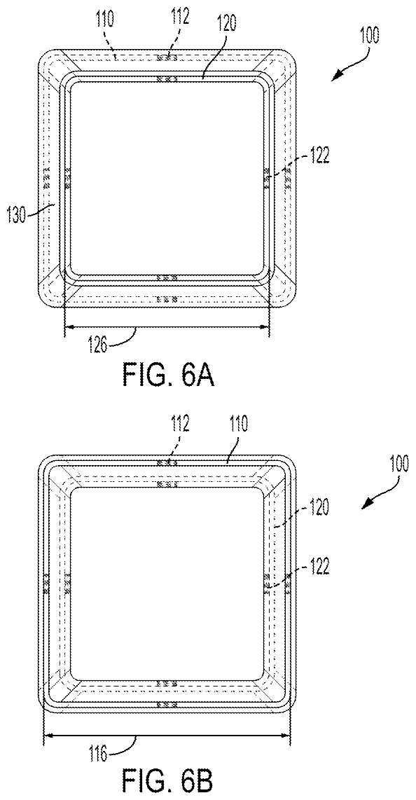

While FIG. 3, FIG. 4A, and FIG. 4B shows the joint (100) having a circular radial cross-sectional profile, FIG. 5, FIG. 6A, and FIG. 6B shows a joint having a polygonal radial cross-sectional profile. The polygonal radial cross-sectional profile may take on many shapes, with preferred examples of such including a triangle, a square (as shown in FIG. 5, FIG. 6A, and FIG. 6B), a rectangle, a hexagon, and an octagon.

FIG. 5 depicts an axial cross section view of an alternative embodiment of a joint (100) having a polygonal (in this case a square) radial cross-sectional profile. As shown in FIG. 5, the joint may comprise a lower flange (110), an upper flange (120), and a transition section (130) which connects the lower flange to the upper flange. The lower flange will have a lower flange external dimension perpendicular to and encompassing a joint central axis (140). This lower flange external dimension is preferably greater than an upper flange external dimension with the upper flange external dimension being perpendicular to and encompassing the joint central axis. As used herein and in the claims, the term “external dimension” refers to the perimeter of the lower flange or the upper flange when viewed in an axial cross section. FIG. 5 also shows the lower flange lip (118) between the lower flange and the transition section, and the upper flange lip (128) between the upper flange and the transition section.

When the lower flange (110) has a polygonal radial cross-sectional profile, the lower flange will comprise at least three lower flange first sidewalls. As shown in FIG. 5, there may be at least one lower flange hole (112) passing through at least one of the lower flange sidewalls in a direction perpendicular to the joint central axis (140). The number of lower flange hole(s) is not considered important and will depend upon a number of factors. That is to say that the at least one lower flange hole may comprise a number of lower flange holes selected from the group consisting of at least two, at least four, at least six, and at least eight. In some embodiments, at least one of the lower flange holes may be threaded to allow for said lower flange hole to receive threads of a fastener—such as a bolt, or a fastener of the type described herein and shown in FIG. 9 and FIG. 10. Preferably, each of the lower flange holes will be threaded to allow for said lower flange holes to receive threads of such a fastener. Preferably, each lower flange sidewall will comprise at least one lower flange hole.

When the upper flange (120) has a polygonal radial cross-sectional profile, the upper flange will comprise at least three upper flange first sidewalls. As shown in FIG. 5, there may be at least one upper flange hole (122) passing through at least one of the upper flange sidewalls in a direction perpendicular to the joint central axis (140). The number of upper flange hole(s) is not considered important and will depend upon a number of factors. That is to say that the at least one upper flange hole may comprise a number of upper flange holes selected from the group consisting of at least two, at least four, at least six, and at least eight. In some embodiments, at least one of the upper flange holes may be threaded to allow for said upper flange hole to receive threads of a fastener—such as a bolt, or a fastener of the type described herein and shown in FIGS. 9 and 10. Preferably, each of the upper flange holes will be threaded to allow for said upper flange holes to receive threads of such a fastener. Preferably, each upper flange sidewall will comprise at least one upper flange hole.

When the lower flange (110) and the upper flange (120) have a polygonal radial cross-sectional profile which is not triangular, each flange will have an outer dimension, which is the dimension measured between two opposing parallel sidewalls of the upper flange. That is to say that the lower flange will have a lower flange outer dimension (116 as shown in FIG. 6B) and the upper flange will have an upper flange outer dimension (126 as shown in FIG. 6A).

In embodiments where the lower flange external dimension is greater than the upper flange external dimension, the lower flange outer dimension (116 as shown in FIG. 6B) should be greater than the upper flange outer dimension (124 as shown in FIG. 6A). For example, one embodiment of a joint (100) will have an upper flange having an upper flange outer dimension of approximately 10 in. and a lower flange having a lower flange outer dimension of approximately 12 in. Another example may have an upper flange having an upper flange outer dimension of approximately 8 in. and a lower flange having a lower flange outer dimension of approximately 10 in. Yet another example may have an upper flange having an upper flange outer dimension of approximately 6 in. and a lower flange having a lower flange outer dimension of approximately 8 in. Still another example may have an upper flange having an upper flange outer dimension of approximately 5 in. and a lower flange having a lower flange outer dimension of approximately 6 in. Another example still may have an upper flange having an upper flange outer dimension of approximately 4 in. and a lower flange having a lower flange outer dimension of approximately 6 in. Yet another example may have an upper flange having an upper flange outer dimension of approximately 4 in. and a lower flange having a lower flange outer dimension of approximately 5 in.

In embodiments where the lower flange external dimension is equal to or substantially equal to the upper flange external dimension, the lower flange outer diameter will be equal to or substantially equal to the upper flange outer dimension. For example, one embodiment of a joint (100) will have an upper flange having an upper flange outer dimension of approximately 12 in. and a lower flange having a lower flange outer dimension of approximately 12 in. Another embodiment of a joint will have an upper flange having an upper flange outer dimension of approximately 10 in. and a lower flange having a lower flange outer dimension of approximately 10 in. Still another embodiment of a joint will have an upper flange having an upper flange outer dimension of approximately 8 in. and a lower flange having a lower flange outer dimension of approximately 8 in. Yet another embodiment of a joint will have an upper flange having an upper flange outer dimension of approximately 6 in. and a lower flange having a lower flange outer dimension of approximately 6 in.

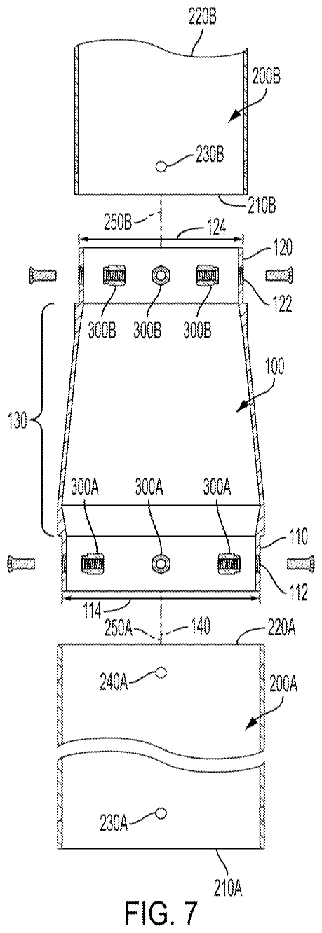

FIG. 7 depicts an exploded axial cross-sectional view of a joint (100) with two pipes (200A and 200B). As shown in FIG. 7, each joint comprises a lower flange (110), an upper flange (120), and a transition section (130) connecting the lower flange to the upper flange. The lower flange and upper flange in FIG. 7 are shown having a circular radial cross-sectional profile, and as such the lower flange comprises a lower flange outer diameter (114) while the upper flange comprises an upper flange outer diameter (124). The lower flange further comprises at least one lower flange hole (112) while the upper flange further comprises at least one upper flange hole (122).

FIG. 7 shows the modular pole (10) comprising two pipes, which may be referred to herein as a first pipe or a lower pipe (200A) and a second pipe or an upper pipe (200B). As shown in FIG. 7, each pipe will have a pipe first end (210A/210B), which is the end of the pipe oriented in the direction of the ground, and a pipe second end (220A/220B), which is the end of the pipe oriented away from the direction of the ground.

Each pipe will further comprise at least one first pipe hole (230A/230B) passing through a sidewall of the pipe at the pipe first end (210A/210B) perpendicular to a pipe central axis (250A/250B). The number of first pipe hole(s) is not considered important and will depend upon a number of factors. That is to say that the at least one first pipe hole may comprise a number of first pipe holes selected from the group consisting of at least two, at least four, at least six, and at least eight. In practice, the number of first pipe holes should be selected to match the number of stud hole(s) ((412) as shown in FIG. 1) or the number of upper flange hole(s) (122) depending upon whether the pipe first end is being connected to a stud ((410) as shown in FIG. 1) or an upper flange.

Each pipe will further comprise at least one second pipe hole (240A/240B) passing through a sidewall of the pipe at the pipe second end (220A/220B) perpendicular to the pipe central axis (250A/250B). The number of second pipe hole(s) is not considered important and will depend upon a number of factors. That is to say that the at least one second pipe hole may comprise a number of second pipe holes selected from the group consisting of at least two, at least four, at least six, and at least eight. In practice, the number of second pipe holes should be selected to match the number of lower flange hole(s) (112) for the individual lower flange to which the pipe second end is intended to be connected.

FIG. 7 also shows the modular pole (10) comprising a plurality of fasteners (300). While FIG. 7 shows the fasteners being of the type disclosed herein and shown in FIG. 9 and FIG. 10, other types of fasteners may be used including a bolt, a bolt and nut, a screw, and a rivet. The plurality of fasteners may be divided into a first subset of the plurality of fasteners (300A) and a second subset of the plurality of fasteners (300B).

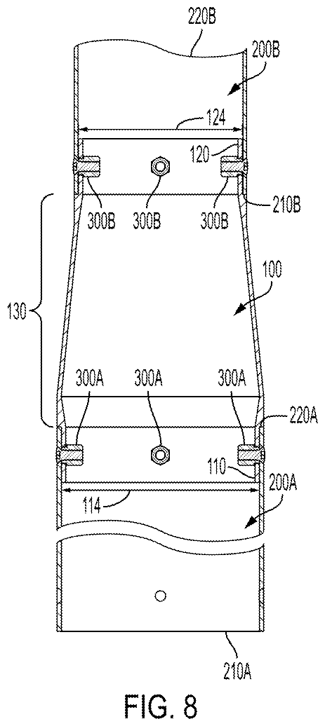

FIG. 8 depicts the axial cross-sectional view of the modular pole (10) of FIG. 7 in assembled form. As shown in FIG. 8, the first subset of the plurality of fasteners (300A) has fixedly connected the first pipe (200A) at the first pipe second end (220A) to the joint lower flange (110). This is done by passing each fastener of the first subset of fasteners through one of the lower flange holes (112 as shown in FIG. 7) and one of the second pipe holes (240A) of the first pipe.

Correspondingly, the second subset of the plurality of fasteners (300B) has fixedly connected the second pipe (200B) at the second pipe first end (210B) to the joint upper flange (120). This is done by passing each fastener of the second subset of fasteners through one of the upper flange holes (122 as shown in FIG. 7) and one of the first pipe holes (230B) of the second pipe. Additional joints and pipes may be connected to increase the height of the modular pole in a similar manner by utilizing additional subsets of the plurality of fasteners.

The pipe may have a variety of different radial cross-sectional profiles. In general, the radial cross-sectional profile of the pipe may be circular or polygonal (i.e.—triangular, square, rectangular, hexagonal, octagonal). It is preferred that the radial cross-sectional profile of the pipe be selected to correspond with the radial cross-sectional profile of the upper flange, lower flange, and/or stud to which the pipe will be connected. That is to say that, when the pipe is intended to be connected at a pipe first end to a stud having a circular radial cross-sectional profile or an upper flange having a circular radial cross-sectional profile and at a pipe second end to a lower flange having a circular radial cross-sectional profile, then the pipe should also have a circular radial cross-sectional profile. Conversely, when the pipe is intended to be connected at a pipe first end to a stud having a polygonal radial cross-sectional profile or an upper flange having a polygonal radial cross-sectional profile and at a pipe second end to a lower flange having a polygonal radial cross-sectional profile, then the pipe should also have a polygonal radial cross-sectional profile with a shape (triangular, square, rectangular, hexagonal, octagonal, etc.) which matches the shape of the corresponding stud or flange(s).

In general, each pipe will have internal dimensions which are slightly larger than the external dimensions of the corresponding stud or flange(s) to which the pipe is intended to be connected. This allows the flanges to be nested within the pipes. As used herein and in the claims when referring to the internal dimensions of the pipe, the term “slightly larger” means that the internal dimensions of the pipe may be between 0.1% and 1.0% greater that the corresponding external dimensions of the stud or flange(s) to which the pipe is intended to be connected. That is to say that, when the pipe first end is intended to be connected to a stud having a circular cross-sectional profile having an external diameter of 9.9 inches, the pipe may have a circular cross-sectional profile with an internal diameter of 10 inches. By keeping the internal dimensions of the pipe slightly larger than the corresponding external dimensions of the stud or flange, the stud or flange may fit within the pipe—i.e., be nested within the pipe—in a manner that allows for easy assembly with limited or no ability for the pipe to rock about its central axis once assembled.

FIG. 9 depicts a side view of one embodiment of a preferred fastener (300). As shown in FIG. 9, the fastener may comprise a fastener first end (310) and a fastener second end (320) opposite the fastener first end. An exterior surface (350) of the fastener spanning from the fastener first end to the fastener second end may be divided into at least a fastener second distance (362) and a fastener third distance (352). The fastener second distance may originate from the fastener second end and terminate before the fastener first end. The exterior surface at the fastener second distance may comprise an outer thread (360) as shown in FIG. 9. The fastener third distance may originate from the fastener first end and terminate before the fastener second end. The exterior surface at the fastener third distance may comprise an axial cross-sectional profile which is hexagonal. Preferably the second distance and the third distance will not overlap. In many embodiments the second distance and the third distance will comprise 100% of the distance between the fastener first end and the fastener second end, although this is not required.

FIG. 10 depicts an axial cross-sectional view of the embodiment of a preferred fastener (300) shown in FIG. 9. As shown in FIG. 10, the fastener may comprise a through hole (330) passing from the fastener first end (310) to the fastener second end (320). The fastener may further comprise an inner thread (340) inside the through hole spanning along a first distance (342) originating from the fastener first end and terminating before the fastener second end. Preferably the first distance does not overlap with the second distance (362 as shown in FIG. 9).

Both the inner thread (340) and the outer thread (360) will have a thread direction. Preferably, the inner thread direction will be opposite of the outer thread direction. That is to say that, when the inner thread direction is a left-hand thread direction, the outer thread direction should be a right-hand thread direction. Conversely, when the inner thread direction is a right-hand thread direction, the outer thread direction should be a left-hand thread direction.

In some embodiments, the fastener (300) may also comprise a bolt (370) as shown in FIG. 9 and FIG. 10. The bolt will comprise external threads (372) spanning along at least a portion of the distance between the bolt first end (374) and the bolt second end (376). These external threads will be mated to the inner threads (340) of the fastener to allow the bolt to be threaded into the through hole (330) during assembly of the modular pole.

In use, the outer thread (360) of the fastener may be mated to internal threads of the stud hole (412), the lower flange hole (112), or the upper flange hole (122) to allow the fastener to be threaded into the stud hole, lower flange hole, or upper flange hole as shown in FIG. 1 (stud hole) and FIG. 8 (upper flange hole and lower flange hole). The bolt (370) may then pass through a pipe hole (230/240) and be threaded into the inner thread (340) of the fastener as shown in FIG. 8. As the inner thread and outer thread have opposite directions, as the bolt is threaded into the inner hole, the torque on the bolt also threads the fastener further into the stud hole, lower flange hole, or upper flange hole, thereby improving the secure fitment of the components to one another.

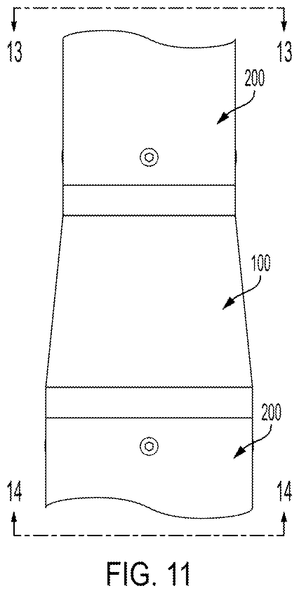

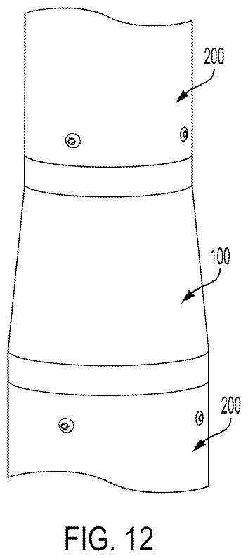

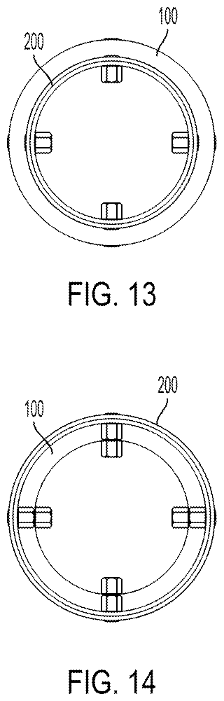

FIG. 11 through FIG. 14 show additional views of an assembly of a joint (100) with two poles (200A and 200B). FIG. 11 shows a side view of such an assembly. FIG. 12 shows a perspective view of such an assembly. FIG. 13 shows a top view of such an assembly. FIG. 14 shows a bottom view of such an assembly.

One or more of the pipes may also include one or more access holes through which a user may access the internal elements of the pole during installation, repair, and maintenance. These access holes may also include an access cover for covering the access hole during times when the pole is not being installed, repaired, or maintained. Examples of such access holes, access covers, and methods of installing access covers are disclosed in co-pending U.S. patent application Ser. No. 17/110,118, the teachings of which are incorporated by reference herein in their entirety.

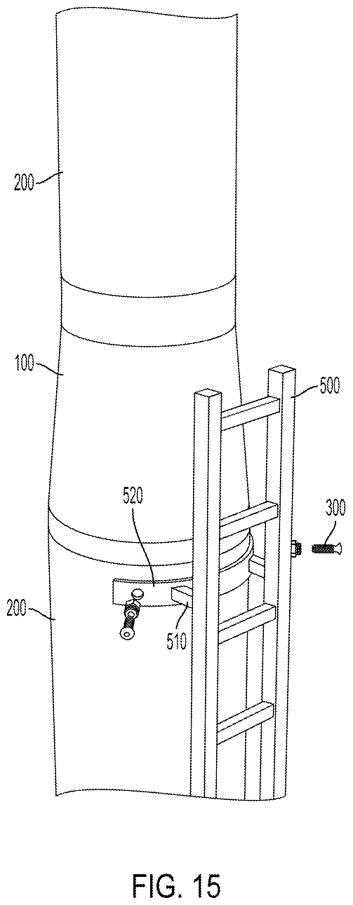

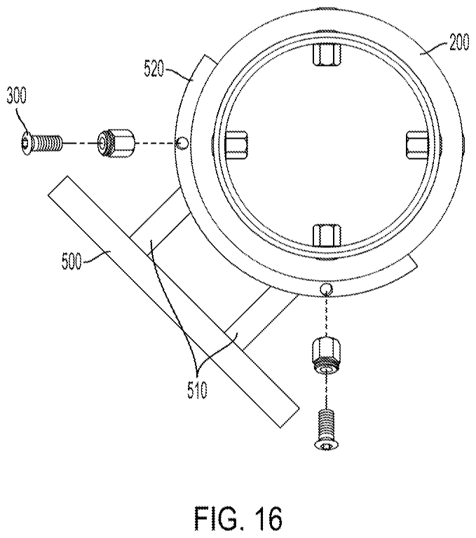

In some embodiments, the modular pole may further comprise a ladder (500) as shown in FIG. 15 and FIG. 16. The preferred ladder (500) will comprise a plurality of ladder braces (510). Each ladder brace will extend between a portion of the ladder and a ladder collar (520). The ladder collar has a profile which generally matches the radial cross-sectional profile of at least one of the pipes. That is to say that—in embodiments where the pipe has radial cross-sectional profile with an outer diameter of approximately 12 in. — the ladder collar will have a semi-circular profile with an arch diameter of approximately 12 in.

The ladder (500) may be connected to the modular pole by passing one or more fasteners (300) through holes in the ladder collar (520) and into corresponding holes of the modular pipe. While FIG. 15 and FIG. 16 show the fasteners being of the same type described herein with reference to FIGS. 9 and 10, other fasteners such as a bolt (with or without a nut), a screw, a rivet, a clamp, or the like may be utilized. In some embodiments, the holes of the modular pipe may be the same holes used to attach a pipe (200) to a joint (100).

The pole described herein is more efficient to manufacture, ship and install. Instead of manufacturing the pole of a single continuous piece of material, the pole may be manufactured in modular sections thus reducing the overall size of the factory needed to manufacture the pole. These modular sections will have a smaller overall profile, thus reducing or eliminating the need for drainage holes during post-manufacturing surface treatments such as galvanizing, painting, or powder coating. The modular sections may also be packed for shipping with a higher number of module sections in each delivery vehicle, thereby increasing the number of poles able to be shipped by any one delivery vehicle and reducing waste in the shipping process. This also allows the pole modules to be manufactured from virtually any location and be shipped to virtually any location with reduced needs for specialized shipping vehicles. Because the modular pole sections are smaller than a single continuous pole, the available footprint around the installation site needed for removing the pole sections from their delivery vehicle and installing the pole is also reduced.

What is claimed is:

1. A joint (100) for a modular pole (10) comprising:
a lower flange (110) comprising at least one lower flange hole (112) passing through a lower flange first sidewall perpendicular to a joint central axis (140);
an upper flange (120) comprising at least one upper flange hole (122) passing through an upper flange first sidewall perpendicular to the joint central axis; and
a transition section (130) connecting the lower flange to the upper flange; and
wherein the lower flange has a lower flange external dimension perpendicular to and encompassing the joint central axis which is greater than or equal to an upper flange external dimension perpendicular to and encompassing the joint central axis.

2. The joint for a modular pole of claim 1, wherein at least one of the lower flange holes is threaded.

3. The joint for a modular pole of claim 1, wherein at least one of the upper flange holes is threaded.

4. The joint for a modular pole of claim 1, wherein each of the upper flange and the lower flange have a circular radial cross-sectional profile.

5. The joint for a modular pole of claim 1, wherein each of the upper flange and the lower flange have a polygonal radial cross-sectional profile.

6. A fastener (300) comprising:
a through hole (330) passing from a fastener first end (310) to a fastener second end (320) which is opposite the fastener first end;
an inner thread (340) inside the through hole spanning along a first distance (342) originating from the fastener first end and terminating before the fastener second end; and
an outer thread (360) on an exterior surface (350) of the fastener spanning along a second distance (362) originating from the fastener second end and terminating before the fastener first end; and
wherein the inner thread has an inner thread direction, the outer thread has an outer thread direction, and the inner thread direction is opposite the outer thread direction.

7. The fastener of claim 6, wherein the first distance does not overlap with the second distance.

8. The fastener of claim 6, wherein a third distance (352) of the exterior surface originating from the fastener first end and terminating before the fastener second end has an axial cross-sectional profile which is hexagonal.

9. The fastener of claim 6, further comprising a bolt (370) comprising external threads (372) which are mated to the inner thread.

10. A modular pole (10) comprising:
Pₙ₊₁ pipes (200);
Tₙ joints (100); and
a plurality of fasteners (300); and
wherein n is an integer greater than or equal to 1;
wherein each joint has a lower flange (110), an upper flange (120), a transition section (130) connecting the lower flange to the upper flange, at least one lower flange hole (112) passing through a lower flange first sidewall perpendicular to a joint central axis (140), and at least one upper flange hole (122) passing through an upper flange first sidewall perpendicular to the joint central axis;
wherein each pipe has a pipe first end (210), a pipe second end (220), at least one first pipe hole (230) passing through a sidewall of the pipe at the pipe first end, and at least one second pipe hole (240) passing through the sidewall of the pipe at the pipe second end;
wherein the lower flange of each joint has a first external dimension perpendicular to and encompassing the joint central axis which is greater than or equal to a second external dimension of the upper flange of said joint perpendicular to and encompassing the joint central axis;
wherein a first subset of the plurality of fasteners is configured to fixedly connect a first pipe of the Pₙ₊₁ pipes to a first joint of the Tₙ joints by passing each fastener of the first subset through one of the lower flange holes of the first joint and one of the second pipe holes of the first pipe; and
wherein a second subset of the plurality of fasteners is configured to fixedly connect the first joint to a second pipe of the Pₙ₊₁ pipes by passing each fastener of the second subset through one of the upper flange holes of the first joint and one of the first pipe holes of the second pipe.

11. The modular pole of claim 10, further comprising a base plate (400) comprising a stud (410) extending substantially vertically therefrom.

12. The modular pole of claim 11, wherein one pipe of the Pₙ₊₁ pipes has an internal dimension perpendicular to a pipe central axis (250) which is greater than a third external dimension of the stud perpendicular to the pipe central axis.

13. The modular pole of claim 11, wherein the stud comprises at least one stud hole (412) passing through a sidewall of the stud, and wherein a third subset of the plurality of fasteners is configured to fixedly connect the one pipe to the stud by passing each fastener of the first subset through one of the first pipe holes of the one pipe and one of the stud holes.

14. The modular pole of claim 11, wherein at least one of the stud holes is threaded.

15. The modular pole of claim 10, wherein each upper flange, each lower flange, and each pipe has a circular radial cross-sectional profile.

16. The modular pole of claim 10, wherein each upper flange, each lower flange, and each pipe has a polygonal radial cross-sectional profile.

17. The modular pole of claim 10, wherein at least one of the lower flange holes of each joint is threaded.

18. The modular pole of claim 10, wherein at least one of the upper flange holes of each joint is threaded.

19. The modular pole of claim 10, further comprising a ladder (500) having at least one ladder collar (520) wherein each ladder collar is configured to connect to at least one of the pipes.

20. The modular pole of claim 10, wherein the plurality of fasteners comprises at least one fastener comprising:
a through hole (330) passing from a fastener first end (310) to a fastener second end (320) which is opposite the fastener first end;
an inner thread (340) inside the through hole spanning along a first distance (342) originating from the fastener first end and terminating before the fastener second end; and
an outer thread (360) on an exterior surface (350) of the fastener spanning along a second distance (362) originating from the fastener second end and terminating before the fastener first end; and
wherein the inner thread has an inner thread direction, the outer thread has an outer thread direction, and the inner thread direction is opposite the outer thread direction.
